(19) United States
(12) Patent Application Publication
(10) Pub. No.: US 2009/0089118 A1
(43) Pub. Date: Apr. 2, 2009

(54) METHOD AND SYSTEM FOR SELECTING SHARED SERVICE CENTERS

(75) Inventors: Steven M. KAGAN, Burr Ridge, IL (US); John A. RICKETTS, Clarendon Hills, IL (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/866,081

(22) Filed: Oct. 2, 2007

(51) Int. Cl. G06F 17/30

(52) U.S. Cl. 705/7

(57) ABSTRACT

A method implemented in a computer infrastructure having computer executable code includes storing collected data representative of service recipient attributes in multiple countries and storing collected data representative of at least one shared service center's (SSC's) attributes. Additionally, the method includes performing a feasibility analysis to determine if one or more SSCs are feasible to provide an indication of one or more feasible SSCs.

### FIELD OF THE INVENTION

The present invention relates to a method and system for selecting shared service centers.

### BACKGROUND OF THE INVENTION

In recent years, there has been a significant growth in managed business process services and business transformation outsourcing. Managed business process services involves options to combine processes, people and technology in outsourced delivery models. Using managed business process services may allow an organization to achieve cost savings, alter their business model and enable strategic transformation.

Business transformation outsourcing involves the transfer of the management and/or day-to-day execution of a portion or an entire business function to an external service provider. Furthermore, outsourcing refers to the delegation of non-core operations from internal production to an external entity specializing in the management of that operation. Outsourcing non-core activities allows an organization to focus on core activities. Business segments typically outsourced include information technology, human resources, facilities and real estate management, and accounting. Many companies also outsource customer support and call center functions, manufacturing and engineering.

A service center is a collection of people with appropriate skills and intellectual capital, technology with suitable capabilities, and physical facilities with adequate capacity, which perform services on behalf of another enterprise or organization. For example, a service center may perform outsourced customer support and call center functions for an enterprise.

A shared service center (SSC) is a service provider having a collection of people with appropriate skills and intellectual capital, technology with suitable capabilities, and physical facilities with adequate capacity, which performs multiple processes for multiple business units within a given enterprise or multiple enterprises. More specifically, an internal SSC delivers services from an internal service provider to multiple business units within a given enterprise. Additionally, an external SSC delivers services from an external service provider to multiple clients (e.g., separate enterprises, businesses, organizations, etc.).

Service recipients are individuals, groups, or organizations receiving services from SSCs. The service recipients can be located in multiple countries and in time zones different from the SSCs that serve them. For example, a SSC may be located in China, but may provide services to a client's Japanese service recipients. Thus, with this example, the SSC and the client's service recipients are in different countries and time zones. Additionally, the SSC must support whatever languages and technologies the client requires for the service recipients. For example, front-office business processes may require telephony, electronic mail, and electronic chat; while back-office processes may require imaging, classification, sorting, routing, and case management technologies.

It should be understood that the service recipients may be different from the client (e.g., the enterprise, business or organization, etc.). For example, if the service is a payroll service for a business, the business is the client. However, the business' employees are the service recipients. As an additional example, if the service is new cellular phone subscription initiation services, the cellular service provider is the client. However, the new subscribers are the service recipients. In selecting a SSC, concern should be given to both the needs of the client and the client's service recipients.

Negotiating a contract and delivering services to a new client (e.g., an enterprise, business, organization, etc.) requires the selection of one or more SSCs to serve that client's service recipients. However, SSCs can be infeasible for several reasons, including:

an SSC not supporting all the required languages spoken/written by service recipients;

an SSC not having all the required technologies;

an SSC not offering all the optional services;

an SSC not being able to attain all the required service levels; and

an SSC not able to expand sufficiently due to limits on space, labor, power, amongst other reasons.

In today's world of international and global multinational corporations, the selection of one or more SSCs may involve a very complex analysis, possibly involving a large number of service centers and a number of parameters. For example, a particular business may have 100 individual business units that operate in 100 countries covering all 24 time zones. Additionally, those individual business units may have different individual service requirements. For example, the individual business units may have different required spoken or written languages, different required technologies, different required standard services, different required optional services, different required service levels, etc. In order to select one or more SSCs that will meet the business' requirements, a business may need to account for each of these requirements.

Moreover, there may be a large number of existing SSCs. Additionally, a client (e.g., an enterprise, business, organization, etc.) may already have existing internal service centers. Thus, in order to select a particular service center, an analysis of the service centers could entail an analysis of a very large number of service centers.

Accordingly, there exists a need in the art to overcome the deficiencies and limitations described hereinabove.

### SUMMARY OF THE INVENTION

In a first aspect of the invention, a method implemented in a computer infrastructure having computer executable code, comprises storing collected data representative of service recipient attributes in multiple countries and storing collected data representative of at least one shared service center's (SSC's) attributes. Additionally, the method comprises performing a feasibility analysis to determine if one or more SSCs are feasible to provide an indication of one or more feasible SSCs.

In additional aspect of the invention, an analysis tool comprises a computer infrastructure operable to consolidate collected data representative of service recipient attributes in multiple countries and consolidate collected data representative of at least one SSC's attributes. Additionally, the analysis tool comprises a computer infrastructure operable to perform a feasibility analysis to determine if one or more SSCs are feasible and provide an indication of one or more feasible SSCs.

In a further aspect of the invention, a computer program product comprising a computer usable medium having readable program code embodied in the medium, wherein the computer program product includes at least one component to consolidate collected data representative of service recipient attributes in multiple countries and consolidate collected data representative of at least one SSC's attributes. Additionally, the computer program product includes at least one component to perform at least one of: a feasibility analysis to determine and indicate if one or more SSCs are feasible; a gap analysis to determine and indicate gaps between the service recipient attributes and the at least one SSC's attributes; and a comparative analysis to compare the at least one SSC's attributes with at least one additional service center's attributes and indicate a comparison.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for managing the processes in accordance with the invention;

FIG. 2 shows an exemplary table of shift differences between a client and a SSC in accordance with an aspect of the invention;

FIG. 3 shows an exemplary graph of time zone differences versus time zone factors in accordance with an aspect of the invention; and

FIG. 4 shows an exemplary flow chart for practicing an aspect of the invention.

### DETAILED DESCRIPTION OF THE INVENTION

The invention relates to a method and system for selecting shared service centers (SSCs). Since the present invention works the same way for both internal and external SSCs, subsequent references to clients and external service providers (e.g., SSCs) should be understood to apply as well to business units served by internal service providers (e.g., SSCs). By implementing aspects of the invention, a client is able to determine one or more appropriate SSCs based on the requirements of the client's service recipients and the abilities of the SSCs. Moreover, by implementing aspects of the invention, a client is able to iteratively adjust parameters, e.g., the service recipient requirement parameters, in the SSC selection process. Additionally, by implementing aspects of the invention, an automated information technology (IT) system may review the pertinent data holistically and may handle a large number of criteria simultaneously. This allows a very thorough and rigorous analysis of the SSCs for selection of one or more appropriate SSCs.

According to an aspect of the invention, attributes of an organization's (or client's) service recipients may be quantified or appraised. Additionally, attributes of one or more SSCs may be quantified or appraised. Moreover, according to a further aspect of the invention, a feasibility analysis may be performed to identify which SSCs may meet client requirements, and conversely, which SSCs are not able to meet client requirements. By implementing this aspect of the invention, a client can determine which SSCs should be considered for selection as potential SSCs for providing services to the client's service recipients.

Additionally, according to a further aspect of the invention, if in performing the feasibility analysis, it is determined that none of the SSCs are able to currently meet all of a client's requirements for their service recipients, a gap analysis may be performed by showing where changes must occur to close gaps between a client's needs and a SSC's abilities. By implementing this aspect of the invention, a client may determine which SSC to select even if none of the SSCs are able to currently meet all of the client's initial requirements.

Furthermore, according to a further aspect of the invention, a comparative analysis may be performed for a client already utilizing their own service center to determine if one or more existing SSCs may be a better option (e.g., more efficient, cheaper, better, etc.) than the client's own service center. By implementing this aspect of the invention, a client may contrast additional service centers with existing SSCs to determine the most appropriate service center.

### Attributes of Service Recipients

In order to determine which SSCs may meet a client's needs, attributes of the client's service recipients may be quantified or appraised. In embodiments, the data representative of the service recipients' attributes may be collected manually. The quantification or appraisal of service recipients' attributes may be thought of as taking an inventory of the service recipients. More specifically, quantification or appraisal of an organization's service recipients may include: data about service recipients' locations (and applicable time zones), which may be in multiple countries; languages that must be supported; technologies that must be available; standard services that are needed; optional services that are needed; and possible service level agreements (SLAs), amongst other service recipient data. Furthermore, as service recipients can be located in multiple countries with time zones different from the SSCs that serve them, this may enable a lower base cost for services. However, on the other hand, as discussed further below, there may be a shift premium to be paid if those services are delivered during evening or night shifts at SSCs.

In order to quantify or appraise the attributes of a client's (e.g., an enterprise's, a business', or an organization's, etc.) service recipients, the service recipients may be segmented. Segmentation may be required as each segment may require different services. For example, if a SSC delivers customer service to a client's customers, those service recipients may be segmented many ways, including by products purchased, spending amount, geographic location, and other individual demographics. As another example, if a SSC performs a business process on behalf of the client's current and former employees, those service recipients may be segmented into regular employees, temporary employees, expatriates, and retirees. As an additional example, if the business process is payroll, segmentation may be important, as expatriates may be more difficult to serve than regular employees, while retirees and temporary employees may be easier to serve. Likewise, a SSC must support whatever languages and technologies the client requires. However, different segments of a client's service recipients may require different languages and/or technologies. For example, front-office business processes may require telephony, electronic mail, and electronic chat, while back-office processes may require imaging, classification, sorting, routing, and case management technologies. Thus, segmentation may aid in providing a thorough analysis for selection of one or more SSCs.

TABLE 1 illustrates four types of service recipients of a client (e.g., an enterprise, business or organization) spread across six countries. It should be understood that TABLE 1 (and each of the following tables) are exemplary embodiments, for illustrating the invention. For example, the tables that follow are smaller than in an actual implementation of this invention in order to keep the illustrations manageable. Naturally, the more rows and columns in each table, the greater the value of the system that performs the analyses as the analyses become increasingly complex.

In an actual analysis, for example, a client may be a global multinational corporation, which provides services to service recipients in, e.g., one hundred countries. Thus, with this example, TABLE 1 would include 100 columns for each of the 100 countries in which the client has service recipients. Additionally, as should be understood, as the client may have more than four types of service recipients, the table may include more rows than the four shown.

As shown in TABLE 1, if the service is, for example, a payroll service, service recipient types could include four types: regular employees (Type 1); temporary employees (Type 2); expatriates (Type 3); and retirees (Type 4). In embodiments, the data representative of the attributes of the service recipients may be manually collected. Moreover, as shown in TABLE 1, the service recipient type data is quantitative data.

TABLE 1
Service Recipient Types.

| Service Recipients | Country 1 | Country 2 | Country 3 | Country 4 | Country 5 | Country 6 | Total |
|---|---|---|---|---|---|---|---|
| Type 1 | 24 | 428 | 48 | 1,222 | 130 | 218 | 2,070 |
| Type 2 | | 214 | | 611 | 65 | 109 | 999 |
| Type 3 | 500 | 5,000 | 3,000 | 20,000 | 6,000 | 8,000 | 42,500 |
| Type 4 | | 43 | | 123 | 13 | 22 | 201 |
| Total | 524 | 5,685 | 3,048 | 21,956 | 6,208 | 8,349 | 45,770 |

As shown in TABLE 1, a client (e.g., an enterprise, business or organization) provides a payroll service to the four types of employees in six different countries. For example, in Country 2, the business entity provides service to 428 regular employees (Type 1), 214 temporary employees (Type 2), 5,000 expatriates (Type 3), and 43 retirees (Type 4). As is further shown in TABLE 1, the service recipients in each country may be summed and the service recipients of each type may be summed. Moreover, the total number of service recipients may be summed.

In selecting one or more SSCs, it may be important to quantify the numbers of service recipients. For example, small numbers of a service recipient type (e.g., 24 service recipients of Type 1 in Country 1) may be important in the analysis, as it may be harder to justify larger expenditures for a smaller number of service recipients.

Additionally, in quantifying or appraising the attributes of a client's service recipients, the languages required for those service recipients, may be appraised. TABLE 2 illustrates five languages required for service recipients. For instance, the languages might include English (Language 1), Japanese (Language 2), French (Language 3), Spanish (Language 4), and German (Language 5). In embodiments, the data representative of the languages required by the service recipients may be manually collected. Moreover, as shown in TABLE 2, the data representative of the languages required by the service recipients is non-quantitative Boolean value data.

TABLE 2
Languages Spoken by Service Recipients.

| | Country | Country | | Country | Country | Country |
|---|---|---|---|---|---|---|
| Languages | 1 | 2 | Country 3 | 4 | 5 | 6 |
| Language 1 | TRUE | TRUE | TRUE | TRUE | TRUE | TRUE |
| Language 2 | FALSE | TRUE | FALSE | FALSE | FALSE | FALSE |
| Language 3 | FALSE | FALSE | TRUE | FALSE | FALSE | FALSE |
| Language 4 | FALSE | FALSE | FALSE | FALSE | FALSE | TRUE |
| Language 5 | FALSE | FALSE | FALSE | FALSE | TRUE | FALSE |

As shown in TABLE 2, for example, in Country 3 a client's service recipients require both English (Language 1) and French (Language 3). Thus, as is discussed further below, in order for a SSC to be feasible for this client in Country 3, the SSC should be proficient or fluent in English and French in Country 3.

Additionally, in quantifying or appraising the attributes of a client's service recipients, the optional services that may be required by the client's service recipients may be appraised. TABLE 3 illustrates four optional services required by the client in selected countries. For instance, if the service is payroll, optional services could include escheatments (Option 1), garnishments (Option 2), accounting (Option 3), and tax filings (Option 4). In embodiments, data representative of the optional services required by the service recipients may be manually collected. Moreover, as shown in TABLE 3, the data representative of the optional services required by the service recipients is non-quantitative Boolean value data.

TABLE 3
Optional Services Required by Client.

| Optional | Country | | Country | | Country | Country |
|---|---|---|---|---|---|---|
| Services | 1 | Country 2 | 3 | Country 4 | 5 | 6 |
| Option 1 | TRUE | FALSE | TRUE | TRUE | TRUE | FALSE |
| Option 2 | FALSE | FALSE | TRUE | FALSE | FALSE | FALSE |
| Option 3 | TRUE | FALSE | TRUE | FALSE | TRUE | TRUE |
| Option 4 | FALSE | FALSE | FALSE | TRUE | TRUE | FALSE |

As shown in TABLE 3, for example, in Country 3 a business may require the optional services of escheatments (Option 1), garnishments (Option 2), accounting (Option 3). Thus, as is discussed further below, in order for a SSC to be feasible for this client in Country 3, the SSC should provide the optional services of escheatments, garnishments, accounting in Country 3.

Additionally, in quantifying or appraising the attributes of a client's service recipients, the technologies required by the client for service to recipients may be appraised. TABLE 4 illustrates, for example, three technologies required by the client for service to recipients in selected countries. For instance, those technologies might include specific computer hardware and software (Technology 1), networking (Technology 2), or telephony (Technology 3).

TABLE 4
Technologies Required by Client.

| | Country | Country | Country | Country | Country | Country |
|---|---|---|---|---|---|---|
| Technologies | 1 | 2 | 3 | 4 | 5 | 6 |
| Technology 1 | TRUE | TRUE | TRUE | TRUE | TRUE | TRUE |
| Technology 2 | FALSE | FALSE | TRUE | FALSE | TRUE | TRUE |
| Technology 3 | FALSE | TRUE | FALSE | FALSE | FALSE | FALSE |

As shown in TABLE 4, for example, in Country 3 a business may require the technologies of specific computer hardware and software (Technology 1), networking (Technology 2). Thus, as is discussed further below, in order for a SSC to be feasible for this client in Country 3, the SSC should provide the technologies of specific computer hardware and software and networking.

Additionally, in quantifying or appraising the attributes of a client's service recipients, the time zones of the client's service recipients may be quantified. TABLE 5 illustrates time zones in each country. In embodiments, if a country spans multiple zones, one time zone may be selected as the primary zone, or each time zone may be entered in a separate column.

TABLE 5
Time Zones in Each Country.

| | Country | Country | Country | | Country | Country |
|---|---|---|---|---|---|---|
| Time Zones | 1 | 2 | 3 | Country 4 | 5 | 6 |
| Abbreviation | AEST | JST | CET | EST | CET | UTC |
| UTC offset | 10 | 9 | 1 | −5 | 1 | 0 |

As shown in TABLE 5, offsets are expressed relative to Coordinated Universal Time (UTC). For instance, the United Kingdom (UTC) is zero, the Eastern United States (EST) is −5, Australia (AEST) is +10.

Additionally, in quantifying or appraising the attributes of a client's service recipients, the service level agreements required by the client for the service recipients may be quantified. TABLE 6 illustrates service level agreements (SLAs) in index form (i.e., expressed on a common scale from zero to one to facilitate comparisons of measures on incompatible scales). For example, the SLAs may include speed, cost, quality and satisfaction.

TABLE 6
Service Level Agreements.

| | Country | Country | | Country | Country | Country |
|---|---|---|---|---|---|---|
| SLAs | 1 | 2 | Country 3 | 4 | 5 | 6 |
| Speed | 0.98 | 0.95 | 0.98 | 0.96 | 0.92 | 0.95 |
| Cost | 0.98 | 0.95 | 0.98 | 0.96 | 0.92 | 0.95 |
| Quality | 0.98 | 0.95 | 0.98 | 0.96 | 0.92 | 0.95 |
| Satisfaction | 0.98 | 0.95 | 0.98 | 0.96 | 0.92 | 0.95 |

As shown in TABLE 6, a higher index value indicates a higher service level required by the client for their service recipients. For example, if the index value is 0.98, then the client requires that the service level be met 98% of the time. In a front-office process, speed SLAs can include, for example, average speed of a phone call answer as well as average handle time. Additionally, in a back-office process, for example, speed SLAs can include time to acknowledge as well as average cycle time. Furthermore, a cost SLA is the price paid by the client to the service provider, e.g., the SSC and is not the service provider's cost. In a front-office process, quality SLAs can include, for example, first-call resolution. Additionally, in a back-office process, quality SLAs may include, for example, rework to correct errors. Moreover, a satisfaction SLA is the rating service recipients give to the service providers for the services received from the service provider, e.g., a SSC. Thus, for example, in Country 3, the client requires that a SSC be able perform services such that they receive positive ratings from the service recipients at a rate of at least 98%.

In embodiments, SLAs may change until a client selects a particular SSC and contract negotiations are completed. Thus, according to a further aspect of the invention, the analysis may be altered by iteratively changing the SLAs as is discussed further below.

### Attributes of SSCs

According to an aspect of the invention, attributes of SSCs may be quantified or appraised. In embodiments, the data representative of the SSC attributes may be collected manually. More specifically, attributes of the SSCs may include: the various time zones of the SSCs; languages supported by the SSCs; the technologies utilized by the SSCs; the standard services of the SSCs; the optional services provided by the SSCs; SSC productivity rates; SSC cost indexes; SSC resource allocations, and SSC attainable service levels, amongst other SSC attributes. Service levels can include but are not limited to cost, speed, quality, and satisfaction. Additionally, the specific skills, experience, and technologies available at each SSC affect the optional services they offer and the service levels they can attain.

In quantifying or appraising the attributes of the SSCs, ratios of service recipients to full-time equivalent resources (FTEs) delivering standard services from SSCs on behalf of the service provider may be quantified. Full-time equivalent (FTE) is a way to measure, for example, a worker's involvement in a process. An FTE has a lower bound of zero and no upper bound. An FTE of 1.0 means that the person is equivalent to a full-time employee, while an FTE of 0.5 signals that the employee is only half-time. Moreover, an FTE of 1.2 may signify a full time employee working some overtime (e.g., 6 days a week). As a further example, five part-time employees working ½ days would have an FTE of 2.5.

TABLE 7 illustrates ratios of service recipients to full-time equivalent resources (FTEs) delivering standard services from SSCs on behalf of the service provider. In other words, TABLE 7 illustrates a number of FTEs per 1,000 recipients of standard services. A smaller ratio indicates a higher level of efficiency. Additionally, these ratios are specific to a given set of services and service recipients. Hence, the ratios can vary enormously. Additionally, the FTE ratios may indicate potential triggers for trade-offs. For example, an SSC in a country, e.g., India, may have half the cost of another SSC, but may have an FTE ratio of 2.0. Thus, while the SSC in India may use less expensive labor, as compared to the other SSC, this advantage may be offset to some degree by inefficiency.

TABLE 7
Standard FTE Ratios.

| Standard | Country | | | Country | Country | Country |
|---|---|---|---|---|---|---|
| Ratios | 1 | Country 2 | Country 3 | 4 | 5 | 6 |
| Standard 1 | 0.65 | 0.98 | 0.33 | 0.81 | 0.59 | 0.72 |
| Standard 2 | 0.50 | 0.75 | 0.25 | 0.63 | 0.45 | 0.55 |
| Standard 3 | 1.00 | 1.50 | 0.50 | 1.25 | 0.90 | 1.10 |
| Standard 4 | 2.00 | 3.00 | 1.00 | 2.50 | 1.80 | 2.20 |

Furthermore, it may take more effort to deliver services to recipients in some countries because, for example, the laws, regulations, products, and markets may be more complex. Hence, even for a specified set of services and recipients, the standard ratios may vary from country to country.

Additionally, in quantifying or appraising the attributes of the SSCs, ratios of service recipients to full-time equivalent resources (FTEs) delivering optional services from SSCs on behalf of the service provider may be quantified. TABLE 8 illustrates ratios of service recipients to FTEs in SSCs for optional services in each country. In other words, TABLE 8 illustrates a number of FTEs per 1,000 recipients of optional services. A smaller ratio indicates a higher level of efficiency.

TABLE 8
Optional FTE Ratios.

| Optional | | | Coun- | Coun- | Coun- | Coun- |
|---|---|---|---|---|---|---|
| Ratios | Country 1 | Country 2 | try 3 | try 4 | try 5 | try 6 |
| Option1 | 0.33 | 1.43 | 0.49 | 0.18 | 0.84 | 1.00 |
| Option2 | 0.65 | 0.00 | 0.11 | 0.32 | 0.00 | 0.00 |
| Option3 | 0.49 | 1.32 | 0.28 | 0.00 | 0.40 | 0.33 |
| Option4 | 0.17 | 0.50 | 0.43 | 0.35 | 0.74 | 0.97 |

Furthermore, in quantifying or appraising the attributes of SSCs, the optional services offered by the SSCs may be appraised. For example, TABLE 9 illustrates optional services offered by each of four SSCs. For instance, if the service is payroll, optional services could include escheatments (Option 1), garnishments (Option 2), accounting (Option 3), and tax filings (Option 4). In this example, since all SSCs have been engineered to offer all optional services, none of the SSCs can be infeasible on this criterion.

TABLE 9
Optional Services by SSC.

| Optional Services | SSC1 | SSC2 | SSC3 | SSC4 |
|---|---|---|---|---|
| Option 1 | TRUE | TRUE | TRUE | TRUE |
| Option 2 | TRUE | TRUE | TRUE | TRUE |
| Option 3 | TRUE | TRUE | TRUE | TRUE |
| Option 4 | TRUE | TRUE | TRUE | TRUE |

Additionally, in quantifying or appraising the attributes of SSCs, the languages supported by the SSCs may be appraised. For example, TABLE 10 illustrates languages supported by each of four SSCs. For instance, the languages might include English (Language 1), Japanese (Language 2), French (Language 3), Spanish (Language 4), and German (Language 5). In embodiments, the data representative of the languages supported by the SSCs may be manually collected. Moreover, as shown in TABLE 10, the data representative of the languages supported by the SSCs is non-quantitative Boolean value data.

TABLE 10
Languages by SSC.

| Languages | SSC 1 | SSC 2 | SSC 3 | SSC 4 | Adder |
|---|---|---|---|---|---|
| Language 1 | TRUE | TRUE | TRUE | TRUE | 0% |
| Language 2 | FALSE | FALSE | TRUE | FALSE | 50% |
| Language 3 | TRUE | FALSE | FALSE | FALSE | 25% |
| Language 4 | TRUE | FALSE | FALSE | TRUE | 15% |
| Language 5 | TRUE | FALSE | FALSE | FALSE | 30% |

As shown in TABLE 10, for example, SSC 3 can support English (Language 1) and Japanese (Language 2), but none of the other languages. Additionally, since some SSCs are located in countries where certain languages are not native, the SSC may charge a language adder to cover the cost of handling foreign languages. Though not shown, the language adder can be tied to the level of language proficiency provided (e.g., first versus second language). Moreover, the language adders are shown in TABLE 10 as common language adders for each SSC. That is, the language adders are based on the language, and are the same for each SSC. However, in embodiments, the individual SSCs may each have different language adders for each of the languages.

Additionally, in quantifying or appraising the attributes of SSCs, the technologies utilized or supported by the SSCs may be appraised. TABLE 11 illustrates technologies utilized at each SSC. For instance, those technologies might include specific computer hardware and software (Technology 1), networking (Technology 2), or telephony (Technology 3).

TABLE 11
Technologies by SSC.

| Technologies | SSC1 | SSC2 | SSC3 | SSC4 |
|---|---|---|---|---|
| Technology 1 | TRUE | TRUE | TRUE | TRUE |
| Technology 2 | TRUE | FALSE | FALSE | TRUE |
| Technology 3 | FALSE | TRUE | TRUE | FALSE |

As shown in TABLE 11, for example, SSC 3 may utilize or support the technologies of specific computer hardware and software (Technology 1) and telephony (Technology 3). Moreover, as shown in TABLE 11, the inputs are Boolean values. Additionally, investments in technology generally follow demand patterns, so an SSC that meets all requirements except technical ones will likely be considered for such investment.

In quantifying or appraising the attributes of SSCs, the distribution of resources within each SSC may be quantified. TABLE 12 illustrates a distribution of resources within each SSC. Due to differences in education and experience, some SSCs must use resources at higher pay grades to achieve the same service levels as other SSCs.

TABLE 12
Resource Distribution by SSC.

| Resources | SSC1 | SSC2 | SSC3 | SSC4 |
|---|---|---|---|---|
| Resource 1 | 25% | 35% | 30% | 20% |
| Resource 2 | 25% | 30% | 35% | 35% |
| Resource 3 | 25% | 30% | 25% | 20% |
| Resource 4 | 25% | 5% | 10% | 25% |

In quantifying or appraising the attributes of SSCs, the cost indexes for each resource type within each SSC may be quantified. TABLE 13 illustrates cost indexes for each resource type within each SSC. Cost indexes are unit-less numbers used to compare resource costs without differences due to currency, exchange rates or inflation, by tying all pertinent currencies to a single base currency. For example, a particular single unit of a base currency, e.g., the U.S. dollar, may be given a cost index of 1.0, and all the other pertinent currencies are expressed relative to the base currency cost index. It should be understood that any currency may be used as the base currency.

TABLE 13
Cost Indexes by SSC.

| Cost Indexes | SSC1 | SSC2 | SSC3 | SSC4 |
|---|---|---|---|---|
| Resource 1 | 3.00 | 1.50 | 1.00 | 2.00 |
| Resource 2 | 3.30 | 1.65 | 1.10 | 2.20 |
| Resource 3 | 3.60 | 1.80 | 1.20 | 2.40 |
| Resource 4 | 3.90 | 1.95 | 1.30 | 2.60 |

In quantifying or appraising the attributes of SSCs, productivity rates for each resource type within each SSC may be quantified. TABLE 14 illustrates productivity rates for each resource type within each SSC. The productivity rate is a unit-less number, which is a ratio of a unit of work per unit of time. A productivity rate of 1.0 indicates that for a given unit of work, it takes one unit of time. Moreover, as should be understood, a higher productivity rate indicates a higher efficiency.

TABLE 14
Productivity Rates by SSC.

| Productivity | SSC1 | SSC2 | SSC3 | SSC4 |
|---|---|---|---|---|
| Resource 1 | 1.13 | 1.56 | 1.88 | 1.19 |
| Resource 2 | 0.95 | 1.31 | 1.58 | 1.00 |
| Resource 3 | 0.90 | 1.25 | 1.50 | 0.95 |
| Resource 4 | 0.81 | 1.13 | 1.35 | 0.86 |

As shown in TABLE 14, within a SSC, different resources may have different productivity rates based on, e.g., education, expertise, and/or tenure of service. Furthermore, differences in education, experience, training, automation, and turnover may lead to productivity differences. Additionally, the segmentation of the resource types allows for iterations in the SSC selection process to optimize the selection one or more SSCs.

In quantifying or appraising the attributes of SSCs, time zones for each SSC may be quantified. TABLE 15 illustrates time zones for each SSC. As with time zones for the countries in which service recipients are found, the offset for SSC time zones is from UTC.

TABLE 15
Time Zones by SSC.

Time Zones

| | SSC1 | SSC2 | SSC3 | SSC4 |
|---|---|---|---|---|
| Abbreviation | EET | IST | PHT | CST |
| UTC offset | 2 | 5.5 | 8 | −6 |

In quantifying or appraising the attributes of SSCs, attainable service levels for each SSC may be quantified. TABLE 16 illustrates attainable service levels for each SSC. As with service level agreements being negotiated with the client, attainable service levels may be expressed as indexes.

TABLE 16
Attainable Service Levels by SSC.

| SLAs | SSC1 | SSC2 | SSC3 | SSC4 |
|---|---|---|---|---|
| Speed | 0.94 | 0.98 | 0.97 | 0.99 |
| Cost | 0.95 | 0.97 | 0.96 | 0.99 |
| Quality | 0.98 | 0.97 | 0.96 | 0.99 |
| Satisfaction | 0.96 | 0.98 | 0.97 | 0.98 |

As shown in TABLE 16, a higher index value indicates a higher attainable service level by the SSC. For example, if the index value is 0.94, then the SSC can attain the required service level at least 94% of the time.

### System Environment

According to a further aspect of the invention, an analysis tool may utilize the gathered data used to quantify the service recipient attributes and the SSC attributes to perform various analyses. More specifically, an analyst may enter the gathered data into the analysis tool. In embodiments, the analysis tool may be used to perform a feasibility analysis by identifying which SSCs do not meet a client's requirements. Additionally, in embodiments, the analysis tool may be used to perform a gap analysis by showing where changes may occur to close gaps, if any, between an client's (e.g., a business') needs or requirements for their service recipients and SSCs' capabilities. Furthermore, in embodiments, the analysis tool may be used to perform a comparative analysis by contrasting additional service centers (e.g. an organization's existing service centers) with existing SSCs.

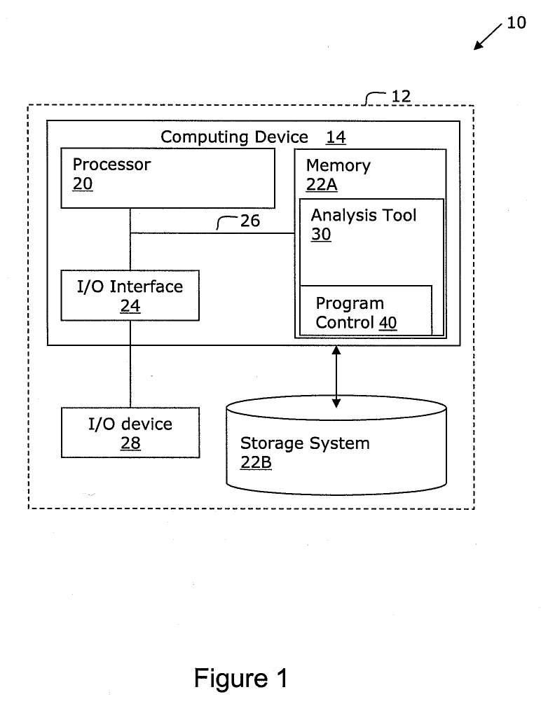

FIG. 1 shows an illustrative environment 10 for managing the processes in accordance with the invention. To this extent, the environment 10 includes a computer infrastructure 12 that can perform the processes described herein.

The computer infrastructure 12 includes a computing device 14 that comprises an analysis tool 30 operable to utilize the compiled or aggregated quantifying data (e.g., the service recipients' attribute data and the SSC attribute data) to perform the feasibility analysis, the gap analysis and/or the comparative analysis, e.g., process described herein. By utilizing the analysis tool 30, a client (e.g., an enterprise, business or organization, etc.) may determine which SSCs may be able to meet the client's service recipients' needs. Moreover, if none of the SSCs are able to meet the service recipients' needs, the analysis tool 30 may determine where gaps between the service recipients' needs and the SSCs' capabilities exist so that those gaps may be closed. Additionally, utilizing the analysis tool 30, capabilities of an organization's existing service centers may be compared to capabilities of SSCs.

The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution.

Further, the computing device 14 is in communication with an external I/O device/resource 28 and a storage system 22B. The external I/O device/resource 28 may be keyboards, displays, pointing devices, etc. Additionally, the analysis tool 30 may use the storage system 22B to contain the complied or aggregated data (e.g., the service recipients' attribute data and the SSC attribute data).

The processor 20 executes computer program code (e.g., program control 40), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14. The I/O device 28 can interact with the computing device 14 or any device that enables the computing device 14 to communicate with one or more other computing devices using any type of communications link.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

### Feasibility Analysis

According to a further aspect of the invention, the analysis tool 30 can perform a feasibility analysis. A SSC may be infeasible for several reasons, including: the SSC does not support all the required languages spoken/written by service recipients; the SSC does not have all the required technologies; the SSC does not offer all the optional services; the SSC is not able to attain all the required service levels; and the SSC cannot expand sufficiently due to limits on space, labor, power, etc., amongst other reasons.

A feasibility analysis therefore eliminates SSCs which cannot meet client, e.g., a business', requirements. Additionally, if multiple SSCs are feasible, the feasibility analysis may aid the client in selecting one or more SSCs that will serve portions of the client's service recipients. This may be a matter of selecting the feasible SSC with the lowest cost, but the feasibility analysis may also take performance, load balancing, and risk management into account. For example, in accounting for risk management, a business may choose to maintain multiple SSCs with comparable capabilities in order to support disaster recovery, provide supplemental capacity, or enable a follow-the-sun service protocol.

TABLE 17 illustrates an exemplary output of the analysis tool 30 indicating language feasibility based upon the inputted service recipient language attributes and the inputted SSC language attributes. More specifically, the analysis tool 30 may determine the results shown in TABLE 17 based upon TABLE 2 and TABLE 10. To satisfy language feasibility, a given SSC must handle all required languages in each country assigned to it.

TABLE 17
Language Feasibility.

| | | | Coun- | Coun- | Coun- | Coun- |
|---|---|---|---|---|---|---|
| Languages | Country 1 | Country 2 | try 3 | try 4 | try 5 | try 6 |
| SSC 1 | TRUE | FALSE | TRUE | TRUE | TRUE | TRUE |
| SSC 2 | TRUE | FALSE | FALSE | TRUE | FALSE | FALSE |
| SSC 3 | TRUE | TRUE | FALSE | TRUE | FALSE | FALSE |
| SSC 4 | TRUE | FALSE | FALSE | TRUE | FALSE | TRUE |

In determining the results shown in TABLE 17, the analysis tool 30 compares the data of TABLE 2 with the data of TABLE 10. Thus, for example, from TABLE 2 it can be observed that the service recipients of the client (e.g., a business) in Country 3 require Language 1 and Language 3. Furthermore, from TABLE 10 it can be observed that SSC 1 is the only SSC that supports Languages 1 and 3. That is, each of the other SSCs do not support both Language 1 and Language 3. Thus, as shown above in TABLE 17 and indicated by a “TRUE,” SSC 1 is the only SSC serving Country 3 that is feasible for the service recipients of the client in Country 3. As a further example, from TABLE 2 it can be observed that the service recipients of the client in Country 6 require Language 1 and Language 4. Furthermore, from TABLE 10 it can be observed that SSC 1 and SSC 4 each support both Languages 1 and 4. Thus, as shown above in TABLE 17 and indicated by “TRUE,” both SSC 1 and SSC 4 are the only SSCs that are feasible for the service recipients of the client in Country 6. In this manner, the analysis tool 30 may generate TABLE 17.

TABLE 18 illustrates an exemplary output of the analysis tool 30 indicating technical feasibility based upon the inputted service recipient technology attributes and the inputted SSC technology attributes. More specifically, the analysis tool 30 may determine the results shown in TABLE 17 based upon TABLE 4 and TABLE 11. To be technically feasible, a given SSC must have all technologies required for each country assigned to it.

TABLE 18
Technical Feasibility.

| Tech- | | | | Coun- | Coun- | Coun- |
|---|---|---|---|---|---|---|
| nologies | Country 1 | Country 2 | Country 3 | try 4 | try 5 | try 6 |
| SSC 1 | TRUE | FALSE | TRUE | TRUE | TRUE | TRUE |
| SSC 2 | TRUE | TRUE | FALSE | TRUE | FALSE | FALSE |
| SSC 3 | TRUE | TRUE | FALSE | TRUE | FALSE | FALSE |
| SSC 4 | TRUE | FALSE | TRUE | TRUE | TRUE | TRUE |

In determining the results shown in TABLE 18, the analysis tool 30 compares the data of TABLE 4 with the data of TABLE 11. Thus, for example, from TABLE 4 it can be observed that the service recipients of the client (e.g., a business) in Country 3 require Technology 1 and Technology 2. Furthermore, from TABLE 11 it can be observed that only SSC 1 and SSC 4 both support Technology 1 and Technology 2. Thus, as shown above in TABLE 18, SSC 1 and SSC 4 would be technically feasible in Country 3 (indicated by “TRUE”) and SSCs 2 and 3 would not be technically feasible in Country 3 (indicated by “FALSE”). In this manner, the analysis tool 30 may generate TABLE 18.

TABLE 19 illustrates an exemplary output of the analysis tool 30 indicating optional service feasibility based upon the inputted service recipient optional service requirement attributes and the inputted SSC optional service attributes. More specifically, the analysis tool 30 may determine the results shown in TABLE 19 based upon TABLE 3 and TABLE 9. To be feasible for optional services, a given SSC must be able to deliver all optional services required for each country assigned to it.

TABLE 19
Optional Service Feasibility.

| Optional | | | Coun- | Coun- | Coun- | Coun- |
|---|---|---|---|---|---|---|
| Services | Country 1 | Country 2 | try 3 | try 4 | try 5 | try 6 |
| SSC 1 | TRUE | TRUE | TRUE | TRUE | TRUE | TRUE |
| SSC 2 | TRUE | TRUE | TRUE | TRUE | TRUE | TRUE |
| SSC 3 | TRUE | TRUE | TRUE | TRUE | TRUE | TRUE |
| SSC 4 | TRUE | TRUE | TRUE | TRUE | TRUE | TRUE |

In determining the results shown in TABLE 19, the analysis tool 30 compares the data of TABLE 3 with the data of TABLE 9. Thus, for example, from TABLE 3 it can be observed that the service recipients of the client (e.g., a business) in Country 3 require Optional Services 1, 2 and 3. Furthermore, from TABLE 9 it can be observed that all the SSCs (SSC 1-SSC 4) support Optional Services 1, 2 and 3. Thus, as shown above in TABLE 19, SSC 1-SSC 4 would be feasible with regard to the Optional Services in Country 3 (indicated by “TRUE”) and none of the SSCs would be infeasible in Country 3 (indicated by “FALSE”). Thus, in this manner, the analysis tool 30 may generate TABLE 19. Additionally, in this example, since all SSCs have been engineered to offer all optional services, none of the SSCs can be infeasible on this criterion.

TABLE 20 illustrates an exemplary output of the analysis tool 30 indicating performance feasibility based upon the inputted service recipient performance requirement attributes and the inputted SSC performance attributes. More specifically, the analysis tool 30 may determine the results shown in TABLE 20 based upon TABLE 6 and TABLE 16. To satisfy performance feasibility, a given SSC must be able to attain all service levels for each country assigned to it.

TABLE 20
Performance Feasibility.

| Perfor- | | | | Coun- | Coun- | Coun- |
|---|---|---|---|---|---|---|
| mance | Country 1 | Country 2 | Country 3 | try 4 | try 5 | try 6 |
| SSC 1 | FALSE | FALSE | FALSE | FALSE | TRUE | FALSE |
| SSC 2 | FALSE | TRUE | FALSE | TRUE | TRUE | TRUE |
| SSC 3 | FALSE | TRUE | FALSE | TRUE | TRUE | TRUE |
| SSC 4 | TRUE | TRUE | TRUE | TRUE | TRUE | TRUE |

In determining the results shown in TABLE 20, the analysis tool 30 compares the data of TABLE 6 with the data of TABLE 16. Thus, for example, from TABLE 6 it can be observed that the service recipients of the client (e.g., a business) in Country 3 require Service Levels for each of speed, cost, quality and satisfaction of 0.98, or 98%. Furthermore, from TABLE 16 it can be observed that only SSC 4 can attain Service Levels for each of speed, cost, quality and satisfaction of 0.98, or 98%. More specifically, SSC 4 is able to attain a Speed Service Level of 0.99, a Cost Service Level of 0.99, a Quality Service Level of 0.99, and a Satisfaction Service Level of 0.98. Thus, as shown above in TABLE 20, only SSC 4 would be feasible with regard to the Service Levels in Country 3 (indicated by “TRUE”) and SSCs 1-3 would be infeasible in Country 3 (indicated by “FALSE”). In this manner, the analysis tool 30 may generate TABLE 20.

Thus, in this manner, the analysis tool 30 may perform a feasibility analysis by comparing the attributes of the service recipients and the attributes of the SSCs. As should be understood, the above-described feasibility analysis may be performed accounting for other attributes of the service recipients and/or SSCs (e.g., standard services, etc.). Moreover, a client may utilize the analysis tool 30 to perform a feasibility analysis and identify one or more feasible SSCs for selection.

### Selection of SSCs

When more than one SSC is feasible for a given country, selection of a specific SSC may be based on, for example, lowest cost, best performance, or best overall balance across SSCs. Since the organization, e.g., business, being illustrated here does not require maximum performance or overall balance, low-cost SSC selection is illustrated below.

Productivity, languages, and time zone differences may impact costs and/or how difficult or easy it may be to meet a client's needs. Thus, to determine the SSC with the lowest cost, the cost rates may take productivity, languages, and time zones into account. Productivity rates were shown above in TABLE 14. Additionally, language adders were shown above in TABLE 10.

TABLE 21 illustrates an exemplary output of the analysis tool 30 indicating time zone differences between each country and each SSC based upon the inputted service recipient time zone attributes and the inputted SSC time zone attributes. More specifically, the analysis tool 30 may generate the results shown in TABLE 21 based upon TABLE 5 and TABLE 15, according to the following equation:

TZ difference=client time zones−SSC time zones. (1)

Moreover, the resultant time zone differences are positive if the client is east of a SSC and negative if the client is west of the SSC, for example.

TABLE 21
Time Zone Differences.

| TZ | | | Coun- | Coun- | Coun- | Coun- |
|---|---|---|---|---|---|---|
| difference | Country 1 | Country 2 | try 3 | try 4 | try 5 | try 6 |
| SSC 1 | 8.00 | 7.00 | −1.00 | −7.00 | −1.00 | −2.00 |
| SSC 2 | 4.50 | 3.50 | −4.50 | −10.50 | −4.50 | −5.50 |
| SSC 3 | 2.00 | 1.00 | −7.00 | −13.00 | −7.00 | −8.00 |
| SSC 4 | 16.00 | 15.00 | 7.00 | 1.00 | 7.00 | 6.00 |

Thus, for example, from TABLE 5 it can be observed that the service recipients of the client (e.g., a business) in Country 3 have a one hour offset relative to Coordinated Universal Time (UTC). Furthermore, from TABLE 15 it can be observed that SSC 1 has a two hour offset relative to UTC, SSC 2 has a 5.5 hour offset relative to UTC, SSC 3 has an eight hour offset relative to UTC, and SSC 4 has a negative six hour offset relative to UTC. Using equation (1), the analysis tool 30 may determine the resulting values shown in the “Country 3” column. Thus, in this manner, using equation (1) the analysis tool 30 may generate TABLE 21.

Furthermore, as can be observed from TABLE 21, there may not be an exact 12 (or 8) hour difference between the client and the SSC. Rather, as shown in TABLE 21, there may be some overlap of shifts (e.g., day shifts, evening shifts, and night shifts).

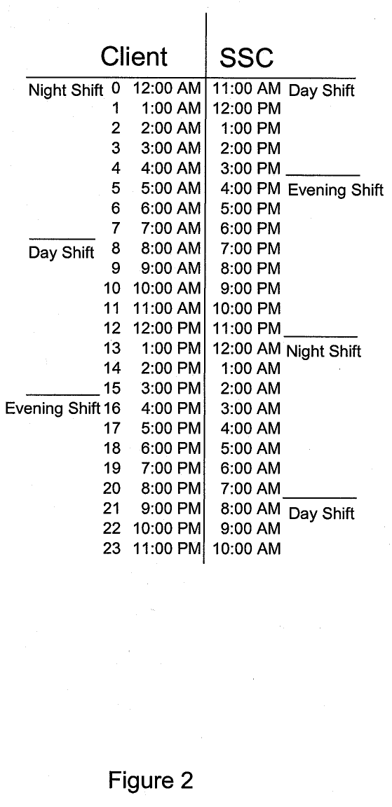

For example, FIG. 2 illustrates the differences between work shifts of a client in a particular country and work shifts at a particular SSC. In this example, a difference in time zones of eleven hours causes the first five business hours in the client's country to correspond to the last five hours of the evening shift at the SSC. Furthermore, as shown in FIG. 2, the last three business hours in the client's country correspond to the first three hours of the night shift at the SSC. Of course, as should be understood, differences in the start and length of shifts would lead to different patterns of overlap.

If an client, e.g., a business, requires 24×7 (i.e., 24 hours a day and 7 days a week) service and the demand is evenly distributed, such time zone differences may not matter. However, if the client requires only 8×5 service, or if it requires 24×7 and demand is much heavier during normal business hours, time zone differences may matter because the service provider (e.g., the SSC) has to provide more resources outside the day shift at the SSC.

In embodiments, a course-grained method or a fine-grained method may be used to account for the time zone differences. A coarse-grained method includes charging shift adders if any part of the client's service hours overlap with evening or night shifts at the SSC. For example, as shown in FIG. 2, because a part of the client's service hours (e.g., during the day shift) overlap with the night shift at the SSC, a night shift adder may be added for all 8 hours of the SSC service during the client's day shift.

Additionally, in embodiments, the analysis tool 30 may account for cost of time zone differences using a fine-grained method. In embodiments, a fine-grained method includes charging shift adders only for the specific hours that overlap. For example, referring again to FIG. 2, because the clients service hours overlap with three hours of the night shift and five hours of the evening shift, a night shift adder may only be added to three hours of the SSC's provided service and an evening shift adder (which may be less then the night shift adder) may be added to the remaining five hours of the SSC's provided service.

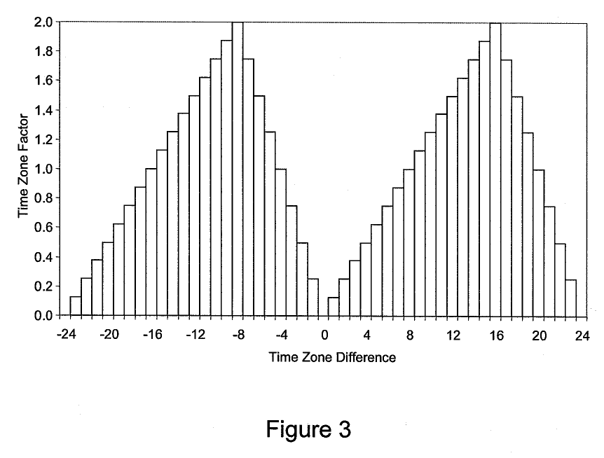

Additionally, in embodiments, the fine-grained method may utilize time zone factors to account for the costs of the time zone differences. FIG. 3 illustrates exemplary resulting time zone factors for various time zone differences. As FIG. 3 is an exemplary illustration, it should not be considered to limit the present invention. With this example, the time zone factor for day shift hours is designated as zero, the time zone factor for the evening shift hours is designated as one, and the time zone factor for night shift hours is designated as two. Furthermore, with these designated time zone factors, the resulting factors for various time zone differences are illustrated in FIG. 3. These resulting time zone factors are bounded by the designated time zone factors (e.g., 0, 1 and 2) for the day (zero time zone difference), evening (e.g., eight or negative sixteen hour time zone difference) and night shifts (e.g., sixteen or negative eight hour time zone difference). Moreover, the values for the intervening time zone differences (e.g., hour differences of one to seven, nine to fifteen and seventeen to twenty-three hours) are determined in a pro-rated manner based on the designated time zone factors (e.g., 0, 1 and 2). Moreover, it should be understood that the invention contemplates different values for the designated time zone factors than those shown in FIG. 3. Additionally, as shown in FIG. 3, the time zone factor for positive two hour difference is the same as a negative twenty-two hour difference (as these differences are equivalent).

TABLE 22 illustrates time zone factors determined using the fine-grained method for the time zone differences illustrated in TABLE 21.

TABLE 22
Time Zone Factors.

| | | | Coun- | Coun- | Coun- | Coun- |
|---|---|---|---|---|---|---|
| TZ factor | Country 1 | Country 2 | try 3 | try 4 | try 5 | try 6 |
| SSC 1 | 1.00 | 0. 88 | 0.25 | 1.75 | 0.25 | 0.50 |
| SSC 2 | 0.56 | 0.44 | 1.13 | 1.69 | 1.13 | 1.38 |
| SSC 3 | 0.25 | 0.13 | 1.75 | 1.38 | 1.75 | 2.00 |
| SSC 4 | 2.00 | 1.8 8 | 0.88 | 0.13 | 0.88 | 0.75 |

More specifically, using the Time Zone Differences to Factors graph of FIG. 3, the analysis tool 30 may convert the time zone differences shown in TABLE 21 into the corresponding Time Zone Factors shown in TABLE 22. For example, as shown in TABLE 21, the difference between Country 1 and SSC 1 is eight hours. Additionally, from FIG. 3, it can be observed that an eight hour time zone difference corresponds to a Time Zone Factor of 1.0 from the vertical axis. Using this method, the analysis tool may generate TABLE 22.

According to a further aspect of the invention, the analysis tool 30 may determine standard resource rates. TABLE 23 illustrates standard resource rates which account for the resource distributions (TABLE 12), the resource cost indexes (TABLE 13) and the resource productivity rates (TABLE 14). The analysis tool 30 determines the standard resource rates by calculating the sumproduct of each column in TABLES 12, 13, and 14. That is, the analysis tool 30 multiplies the cells of each table by the corresponding cells of the other tables and sum the results in each column. For example, with SSC 1, a blended standard resource rate of 3.22=(0.25×3.00×1.13)+(0.25×3.30×0.95)+(0.25×3.60×0.90)+(0.25×3.90×0.81). In this manner, the analysis tool 30 may determine the values of TABLE 23.

TABLE 23
Standard Resource Rates.

Rates

| | SSC1 | SSC2 | SSC3 | SSC4 |
|---|---|---|---|---|
| Blended | 3.22 | 2.25 | 1.79 | 2.25 |

According to a further aspect of the invention, the analysis tool 30 may determine adjusted cost rates which account for productivity, languages and time zones. TABLE 24 illustrates exemplary adjusted cost rates that account for productivity, languages, and time zones.

TABLE 24
Adjusted Rates.

| Adjusted | | | Coun- | Coun- | Coun- | Coun- |
|---|---|---|---|---|---|---|
| rates | Country 1 | Country 2 | try 3 | try 4 | try 5 | try 6 |
| SSC 1 | | | | | 4.51 | |
| SSC 2 | | | | 6.06 | | |
| SSC 3 | | 2.47 | | 4.26 | | |
| SSC 4 | 6.76 | | | 2.54 | | 4.12 |

As shown in TABLE 24, the analysis tool 30 may only determine adjusted rates when a SSC satisfies each of language feasibility (TABLE 17), technical feasibility (TABLE 18), optional service feasibility (TABLE 19) and performance feasibility (TABLE 20). Thus, when an SSC is feasible for a given country across TABLES 17 thru 20, the analysis tool 30 may calculate the adjusted rate.

According to an aspect of the invention, in embodiments, the adjusted rate may be determined according to the following equation:

adj. rate=standard rate×(1+TZ factor+average Language Adder) (2)

For example, from TABLES 17-20, the analysis tool 30 determines that SSC 1 is feasible for Country 5. Moreover, the average language adder for a country may be determined by averaging the applicable language adders for that country. For example, for Country 5, the service recipients require Language 1 (which has a Language Adder of 0%) and Language 5 (which has a Language Adder of 30%). Thus, the average language adder for Country 5 is (0.0+0.3)/2=0.15. Therefore, using equation (2), the analysis tool 30 determines the adjusted rate as 3.22×(1+0.25+0.15)=4.51. In this manner, the analysis tool 30 may determine the adjusted rates shown in the exemplary TABLE 24.

Additionally, for most countries in this exemplary illustration, only one SSC is feasible. This is shown in TABLE 24, in that no values are shown for some of the SSCs in particular countries. Additionally, it can be observed from the exemplary TABLE 24 that no SSC is feasible for Country 3. There are, however, three feasible SSCs for Country 4. However, as SSC 4 has markedly lower cost as compared to SSC 2 and SSC 3, SSC 4 may be selected for Country 4.

### Gap Analysis

According to a further aspect of the invention, if no SSC is currently feasible for a given set of service recipients, the owner/operator of SSCs may utilize the analysis tool 30 to perform a gap analysis to determine what it would take to make current SSCs feasible or to build/acquire new SSCs. Furthermore, the gaps may be non-quantitative gaps (e.g., language feasibility, technical feasibility, optional services feasibility) or quantitative gaps (e.g., SLAs).

The gap analysis may drive contract negotiation and SSC planning. For example, it may be that an existing SSC could meet requirements during the second year of a contract and the client will agree to lower service levels and/or fewer optional services in the interim. As a further example, a language deficit or gap may be identified in the feasibility analysis. This deficit or gap may be eliminated, for example, by hiring native speakers (e.g., either by the SSC or internally by the client) or by lowering language proficiency requirements (e.g., from requiring completely fluent speakers to requiring 2^{nd} language fluency).

Additionally, according to a further aspect of the invention, using the analysis tool 30, the SLAs may be iteratively altered and the feasibility analysis performed again. That is, it may simply be that the client (e.g., the enterprise or business, etc.) started negotiating from a position that is not realistic in the sense that no SSC can attain such service levels. Thus, the client's required SLAs may be adjusted and a feasibility analysis performed again to select a SSC.

As discussed in the example above, Country 3 is notable because none of the SSCs are feasible for Country 3. Thus, according to this aspect of the invention, the analysis tool 30 may be used to identify gaps that make the existing SSCs infeasible for this country so that the gaps may be accounted for or closed.

Since language, technical, and optional service feasibility are Boolean values, gaps are identified by examining the corresponding tables above. Thus, as can be observed from TABLES 17-20, only SSC 1 is feasible on all these criteria in Country 3. However, SSC 1 fails to meet the performance criterion, and thus lacks performance feasibility in Country 3. The performance criterion, however, is actually comprised of several potential SLAs. That is, the performance feasibility is based upon a speed SLA, a cost SLA, a quality SLA and a satisfaction SLA.

TABLE 25 illustrates an output of the analysis tool 30, which indicates the speed differences between what a client, e.g., a business, requires and the SSCs can attain. More specifically, the analysis tool 30 may determine the results shown in TABLE 25 (and TABLES 26-28) by calculating the difference between the corresponding rows of TABLE 16 and TABLE 6. For example, as shown in TABLE 6, a client requires a speed SLA of 0.98 in Country 1, 0.95 in Country 2, 0.98 in Country 3, 0.96 in Country 4, 0.92 in Country 5, and 0.95 in Country 6. Further, as shown in TABLE 16, SSC 1 can attain a speed SLA of 0.94. Accordingly, the analysis tool 30 determines the values shown in TABLE 25 for SSC 1 by subtracting the corresponding values of TABLE 6 (0.98, 0.95, 0.98, 0.96, 0.92 0.95, respectively) from the pertinent value of TABLE 16 (0.94).

TABLE 25
Speed Differences.

| Speed | | | Coun- | Coun- | Coun- | Coun- |
|---|---|---|---|---|---|---|
| difference | Country 1 | Country 2 | try 3 | try 4 | try 5 | try 6 |
| SSC 1 | −0.04 | −0.01 | −0.04 | −0.02 | 0.02 | −0.01 |
| SSC 2 | | 0.03 | | 0.02 | 0.06 | 0.03 |
| SSC 3 | −0.01 | 0.02 | −0.01 | 0.01 | 0.05 | 0.02 |
| SSC 4 | 0.01 | 0.04 | 0.01 | 0.03 | 0.07 | 0.04 |

As shown in TABLE 25, the negative values indicate that a particular SSC is not able to attain the required speed SLA and the positive values indicate that a particular SSC exceeds the required speed SLA. Moreover, the blank areas indicate that a particular SSC is able to attain the exact required speed SLA (and thus have a value of 0.0, which is not shown). For example, as shown in TABLE 25, SSC 1 cannot meet the speed SLA for Country 3.

TABLE 26 illustrates an output of the analysis tool 30, which indicates the cost differences between what a client, e.g., a business, requires and the SSCs can attain. More specifically, the analysis tool 30 may determine the results shown in TABLE 26 by calculating the difference between the corresponding rows of TABLE 16 and TABLE 6 in a similar manner to the determination of the values shown in TABLE 25, described above. As shown in TABLE 26, SSC 1 cannot meet the cost SLA for Country 3.

TABLE 26
Cost Differences.

| Cost | | | Coun- | Coun- | Coun- | Coun- |
|---|---|---|---|---|---|---|
| difference | Country 1 | Country 2 | try 3 | try 4 | try 5 | try 6 |
| SSC 1 | −0.03 | | −0.03 | −0.01 | 0.03 | |
| SSC 2 | −0.01 | 0.02 | −0.01 | 0.01 | 0.05 | 0.02 |
| SSC 3 | −0.02 | 0.01 | −0.02 | | 0.04 | 0.01 |
| SSC 4 | 0.01 | 0.04 | 0.01 | 0.03 | 0.07 | 0.04 |

TABLE 27 illustrates an output of the analysis tool 30, which indicates the quality differences between what a client, e.g., a business, requires and the SSCs can attain. More specifically, the analysis tool 30 may determine the results shown in TABLE 27 by calculating the difference between the corresponding rows of TABLE 16 and TABLE 6 in a similar manner to the determination of the values shown in TABLE 25, described above. As shown in TABLE 27, SSC 1 can meet the quality SLA for Country 3.

TABLE 27
Quality Differences.

| Quality | | | Coun- | Coun- | Coun- | Coun- |
|---|---|---|---|---|---|---|
| difference | Country 1 | Country 2 | try 3 | try 4 | try 5 | try 6 |
| SSC 1 | | 0.03 | | 0.02 | 0.06 | 0.03 |
| SSC 2 | −0.01 | 0.02 | −0.01 | 0.01 | 0.05 | 0.02 |
| SSC 3 | −0.02 | 0.01 | −0.02 | | 0.04 | 0.01 |
| SSC 4 | 0.01 | 0.04 | 0.01 | 0.03 | 0.07 | 0.04 |

TABLE 28 illustrates an output of the analysis tool 30, which indicates the satisfaction differences between what a client, e.g., a business, requires and the SSCs can attain. More specifically, the analysis tool 30 may determine the results shown in TABLE 28 by calculating the difference between the corresponding rows of TABLE 16 and TABLE 6 in a similar manner to the determination of the values shown in TABLE 25, described above. As shown in TABLE 28, SSC 1 cannot meet the satisfaction SLA for Country 3.

TABLE 28
Satisfaction Differences.

| Satisfaction | | Coun- | Coun- | Coun- | Coun- | Coun- |
|---|---|---|---|---|---|---|
| difference | Country 1 | try 2 | try 3 | try 4 | try 5 | try 6 |
| SSC 1 | −0.02 | 0.01 | −0.02 | | 0.04 | 0.01 |
| SSC 2 | | 0.03 | | 0.02 | 0.06 | 0.03 |
| SSC 3 | −0.01 | 0.02 | −0.01 | 0.01 | 0.05 | 0.02 |
| SSC 4 | | 0.03 | | 0.02 | 0.06 | 0.03 |

Thus, the gap analysis indicates that while SSC 1 has the necessary technology, supports the optional services, and handles the required languages, SSC 1 has gaps on three out of four potential SLAs. Additionally, as set forth above, the gap analysis indicates that SSC 4 could meet all the SLAs, has the necessary technology, and supports the optional services, but that SSC 4 has a language gap.

Therefore, utilizing the gap analysis it can be determined that the SSC1 gaps can be closed if the client, e.g., business, is willing to accept lower performance SLAs in that country. This may be negotiable, given that the current performance request may be deemed quite high. Alternatively, the SSC 4 gap may be closed if SSC 4 is able to introduce coverage of a new language into that SSC.

### Comparative Analysis

According to a further aspect of the invention, the analysis tool 30 may be used to perform a comparative analysis to contrast, for example, a client's existing service center with SSCs. For example, if the client, e.g., business, has existing service centers that the client wants the new service provider to take over, that service provider must determine how the client's service centers would fit with the service provider's existing SSCs. This comparative analysis may thus drive contract negotiation and SSC planning. As a further example, it may be that some of the client's service centers are not capable of becoming SSCs and should therefore be phased out. It may also be that the client may choose to keep some of its service centers and use them for other purposes. Of course, it may also be possible for the service provider to turn some of the client's service centers into SSCs that will serve additional clients. Moreover, the service provider might plan to close or consolidate existing SSCs when taking over a client's service centers if they are better than the service provider's existing SSCs.

According to an aspect of the invention, when a client's existing service centers are to be compared to the service provider's SSCs, attributes of the client's service recipients and its service centers may be entered into the tables above as additional rows and columns when collecting the SSC attribute data.

If the client's own service centers are infeasible, there must be an error in the input somewhere since those centers are currently delivering services. Moreover, if the service provider's SSCs are infeasible, using a gap analysis, as described above will indicate alternatives.

A comparative analysis often benefits from a more detailed look at resources. Referring again to the example set forth above, TABLE 29 illustrates unadjusted FTEs by standard and optional services across all countries for the client, e.g., business, discussed above. Moreover, fractional FTEs represent part-time or overtime work.

TABLE 29
Unadjusted FTEs.

| Unadjusted FTEs | Country 1 | Country 2 | Country 3 | Country 4 | Country 5 | Country 6 | Total |
|---|---|---|---|---|---|---|---|
| Standard1 | 0.02 | 0.42 | 0.02 | 0.99 | 0.08 | 0.16 | 1.67 |
| Standard2 | | 0.16 | | 0.38 | 0.03 | 0.06 | 0.63 |
| Standard3 | 0.50 | 7.50 | 1.50 | 25.00 | 5.40 | 8.80 | 48.70 |
| Standard4 | | 0.13 | | 0.31 | 0.02 | 0.05 | 0.51 |
| Option1 | 0.17 | | 1.49 | 3.96 | 5.21 | | 10.83 |
| Option2 | | | 0.32 | | | | 0.32 |
| Option3 | 0.26 | | 0.84 | | 2.49 | 2.79 | 6.37 |
| Option4 | | | | 7.68 | 4.59 | | 12.27 |
| Standard Subtotal | 0.52 | 8.21 | 1.52 | 26.68 | 5.53 | 9.06 | 51.51 |
| Option Subtotal | 0.43 | | 2.65 | 11.64 | 12.28 | 2.79 | 29.79 |
| Grand Total | 0.95 | 8.21 | 4.16 | 38.33 | 17.81 | 11.85 | 81.31 |

According to an aspect of the invention, the analysis tool 30 determines the values of TABLE 29 from number of service recipients of a type from TABLE 1 multiplied either by the Standard FTE Ratios from TABLE 7 or by the Optional FTE Ratios from TABLE 8 and divided by 1000, or according to one of the following equations:

unadj. FTE=service recipients (of type)×standard FTE ratio/1000; (3)

or

unadj. FTE=service recipients (of type)×optional FTE ratio/1000. (4)

For example, in determining the unadjusted FTE for Standard 1 in Country 1, using equation (3) the analysis tool 30 calculates: 24×0.65/1000=0.0156≈0.02. As a further example, in determining the unadjusted FTE for Option 3 in Country 3, using equation (4) the analysis tool 30 calculates: 3,000×0.28/1000=0.84. Additionally, as shown in TABLE 29, the analysis tool may round off the determined values. Additionally, the analysis tool determines the values around the margin of TABLE 29 by summing the cells within the table.

TABLE 30 illustrates blended productivity rates for the SSCs. The analysis tool 30 may determine the values of TABLE 30 based on the sumproduct of columns within TABLES 12 & 14. For example, the analysis tool determines the blended productivity rate for SSC 1 as 0.9475=(0.25×1.13)+(0.25×0.95)+(0.25×0.90)+(0.25×0.81).

TABLE 30
Blended Productivity Rates.

Rates

| | SSC1 | SSC2 | SSC3 | SSC4 |
|---|---|---|---|---|
| Blended Productivity | 0.9475 | 1.3705 | 1.627 | 0.993 |

TABLE 31 illustrates adjusted FTEs by SSC. According to an aspect of the invention, the analysis tool 30 determines the values shown in TABLE 31 (for countries where there is a feasible SSC) by multiplying the Grand Total of Unadjusted FTEs from TABLE 29 times Blended Productivity Rates from TABLE 30 and rounds up, e.g., to the nearest quarter of an FTE. For example, Blended Productivity Rate for SSC1 is 0.9475, and the Unadjusted FTEs for Country 5 is 17.81, the product of which is 16.87, which rounds up to 17. Additionally, as shown in TABLE 31, the analysis tool 30 cannot determine Adjusted FTEs for Country 3 because no SSC is currently feasible.

TABLE 31
Adjusted FTEs.

| Adjusted | | | | | | |
|---|---|---|---|---|---|---|
| FTEs | | Country 2 | | Country 4 | Country 5 | Country 6 |
| SSC 1 | | | | | 17.00 | |
| SSC 2 | | | | | | |
| SSC 3 | | 13.50 | | | | |
| SSC 4 | 1.00 | | | 38.00 | | 11.75 |
| Total | 1.00 | 13.50 | 0.00 | 38.00 | 17.00 | 11.75 |

The adjustment accounts for differences in productivity that have to be made up by increasing FTEs to provide equivalent service levels at SSCs with lower productivity. Furthermore, the FTEs can be rounded to any fractional value, e.g., nearest quarter in this illustration, to facilitate hiring and training plans. If the SSCs have load-balancing capability, some disparities can be resolved by delivering work assigned to one SSC from a remote SSC with sufficient capabilities. This is yet another way to close gaps.

Additionally, in embodiments, if the service provider's SSCs are selected, the client's service centers may best be phased out. Conversely, in embodiments, if the client's service centers are selected, some of the provider's SSCs might best be migrated to those centers.

In addition to comparing the client's service centers to the provider's SSCs in this manner, comparative analysis may also be used to evaluate other service providers for merger or acquisition. Of course, if another service provider has complementary capabilities, a merger or acquisition could close gaps between each of their capabilities.

Thus, as described above, the analysis tool 30 may be utilized to perform a comparative analysis between SSCs and, e.g., a clients existing service centers. This may assist a client in determining whether to select a SSC to provide services to a client's service recipients, instead of using, e.g., a client's existing service centers.

### Flow Diagram

The steps of the flow diagram described herein may be implemented in the environment of FIG. 1. The flow diagram may equally represent a high-level block diagram of the invention. The steps of the flow diagram may be implemented and executed from either a server, in a client server relationship, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

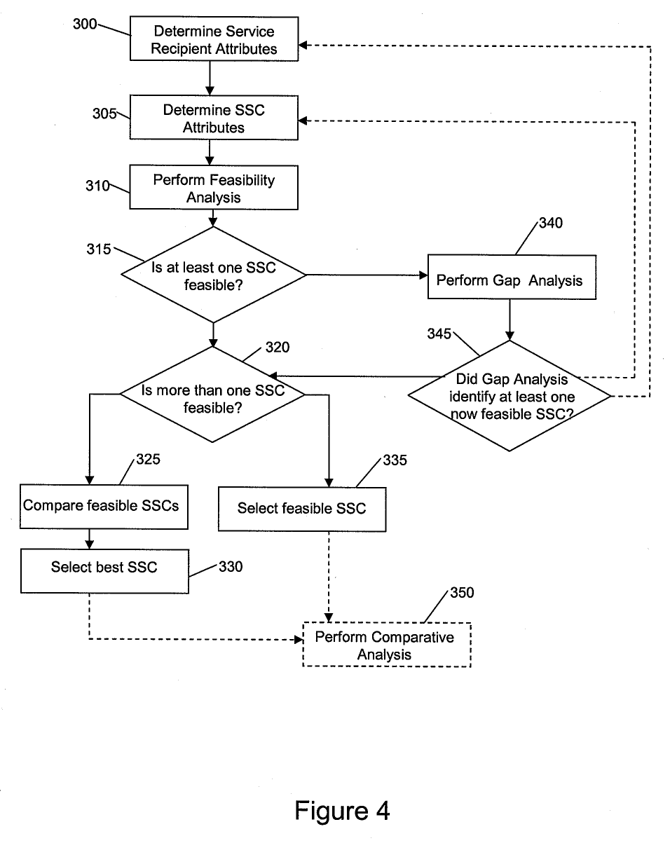

FIG. 4 shows an exemplary flow chart for performing steps of the invention. At step 300, the service recipient attributes may be determined. At step 305, the SSC attributes may be determined. At step 310, an analysis tool 30 performs a feasibility analysis. At step 315, a determination is made as to whether at least one SSC is feasible. If, at step 315, at least one SSC is determined to be feasible, then, at step 320, a determination is made as to whether more than one SSC is feasible. If, at step 320, more than one SSC is determined to be feasible, at step 325, the analysis tool 30 compares the feasible SSCs. At step 330, a best SSC from among the more than one feasible SSCs is selected. If, at step 320, it is determined that only one SSC is feasible, at step 335, the one feasible SSC may be selected.

If, at step 315, no SSC is determined to be feasible, then, at step 340, the analysis tool 30 may perform a gap analysis. At step 345, a determination is made as to whether the gap analysis aided in identifying at least one now feasible SSC. If, at step 345, the gap analysis identified at least one now feasible SSC, the process continues at step 320.

If, at step 345, the gap analysis did not identify at least one now feasible SSC, the process may continue either at step 300 (where the service attributes may be reevaluated, e.g., SLAs may be iteratively adjusted) or step 305 (where the SSC attributes may be reevaluated, e.g., a SSC may decide to upgrade their technology support) to alter the results of the feasibility analysis of the analysis tool 30. As, in embodiments, the reversion to step 300 and/or step 305 may be optional, the lines are shown as hidden lines. At step 350, the analysis tool 30 may perform a comparative analysis. As, in embodiments, step 350 may be an optional step, step 350 is shown in hidden lines.

While the exemplary process of FIG. 4 is shown in a particular order, it should be understood that the invention contemplates other orders of steps. For example, step 300 may be performed after step 305. Moreover, step 350 may be performed earlier in the process, e.g., anytime after steps 300 and 305.

While the invention has been described in terms of embodiments, those of skill in the art will recognize that the invention can be practiced with modifications and in the spirit and scope of the appended claims.

What is claimed is:

1. A method implemented in a computer infrastructure having computer executable code, comprising:
storing collected data representative of service recipient attributes in multiple countries;
storing collected data representative of at least one shared service center's (SSC's) attributes; and
performing a feasibility analysis to determine if one or more SSCs are feasible to provide an indication of one or more feasible SSCs.

2. The method of claim 1, further comprising:
performing a gap analysis if none of the SSCs are determined feasible; and
indicating results of the gap analysis.

3. The method of claim 1, further comprising:
performing a comparative analysis to compare at least one SSC with a client's at least one existing service center; and
indicating results of the comparative analysis.

4. The method of claim 1, wherein the data representative of service recipient attributes comprises at least one of:
service recipient types;
required language support;
required standard services;
required optional services;
required technologies;
service recipient time zones; and
required service level agreements (SLAs), which comprise at least one of speed SLAs, cost SLAs, quality SLAs, and satisfaction SLAs.

5. The method of claim 1, wherein the data representative of SSC attributes comprises at least one of:
languages supported;
standard services provided;
optional services provided;
technologies supported;
SSC time zones;
attainable service level agreements (SLAs), comprising at least one of attainable speed SLAs, attainable cost SLAs, attainable quality SLAs, and attainable satisfaction SLAs;
SSC resource distributions;
SSC cost indexes;
SSC productivity rates;
standard full-time equivalent ratios; and
optional full-time equivalent ratios.

6. The method of claim 1, further comprising, if at least one SSC is determined feasible, selecting at least one feasible SSC to provide service to service recipients in at least one of the multiple countries.

7. The method of claim 1, further comprising, if more than one SSC is determined feasible, selecting at least one SSC based on a determination of at least one of:
lowest cost;
best performance; and
best overall balance.

8. The method of claim 7, wherein the determination of lowest cost comprises accounting for at least one of:
productivity costs;
language costs; and
time zone costs.

9. The method of claim 8, wherein accounting for the productivity costs comprises determining the productivity costs accounting for at least one of:
resource distributions;
cost indexes; and
productivity rates.

10. The method of claim 8, wherein accounting for the language costs comprises using at least one language adder to determine the language costs and wherein accounting for the time zone costs comprises determining shift adders utilizing at least one of:
a coarse-grained method;
a fine-grained method; and
time zone factors.

11. The method of claim 1, wherein a service provider at least one of creates, maintains, deploys and supports the computer infrastructure that performs the steps of claim 1.

12. The method of claim 1, wherein steps of claim 1 are provided by a service provider on a subscription, advertising, and/or fee basis.

13. An analysis tool comprising a computer infrastructure operable to:
consolidate collected data representative of service recipient attributes in multiple countries;
consolidate collected data representative of at least one SSC's attributes; and
perform a feasibility analysis to determine if one or more SSCs are feasible and provide an indication of one or more feasible SSCs.

14. The analysis tool of claim 13, wherein the computer infrastructure is operable to perform a gap analysis to determine gaps between the service recipient attributes and the at least one SSC's attributes.

15. The analysis tool of claim 13, wherein the computer infrastructure is operable to perform a comparative analysis to compare the at least one SSC's attributes with at least one additional service center's attributes.

16. The analysis tool of claim 13, wherein the collected data representative of service recipient attributes comprises at least one of:
service recipient types;
required language support;
required standard services;
required optional services;
required technologies;
service recipient time zones; and
required service level agreements (SLAs).

17. The analysis tool of claim 13, wherein the collected data representative of at least one SSC's attributes comprises at least one of:
languages supported;
standard services provided;
optional services provided;
technologies supported;
SSC time zones;
attainable service level agreements (SLAs);
SSC resource distributions;
SSC cost indexes;
SSC productivity rates;
standard full-time equivalent ratios; and
optional full-time equivalent ratios.

18. The analysis tool of claim 13, wherein the computer infrastructure is operable to select, if more than one SSC is determined feasible, a SSC based on a determination of at least one of:
lowest cost;
best performance; and
best overall balance.

19. The analysis tool of claim 18, wherein the determination of lowest cost comprises accounting for at least one of:
productivity costs determined from at least one of resource distributions, cost indexes, and productivity rates;
language costs determined using at least one language adder; and
time zone costs determined using shift adders based on at least one of a coarse-grained method, a fine-grained method, and time zone factors.

20. A computer program product comprising a computer usable medium having readable program code embodied in the medium, the computer program product includes at least one component to:
consolidate collected data representative of service recipient attributes in multiple countries;
consolidate collected data representative of at least one SSC's attributes; and
perform at least one of:
a feasibility analysis to determine and indicate if one or more SSCs are feasible;
a gap analysis to determine and indicate gaps between the service recipient attributes and the at least one SSC's attributes; and
a comparative analysis to compare the at least one SSC's attributes with at least one additional service center's attributes and indicate a comparison.
